(19) United States
(12) Patent Application Publication
(10) Pub. No.: US 2015/0264290 A1
(43) Pub. Date: Sep. 17, 2015

(54) CAMERA MODULE

(71) Applicant: KABUSHIKI KAISHA TOSHIBA, Tokyo (JP)

(72) Inventors: Akihiko HAPPOYA, Oume Tokyo (JP); Daigo SUZUKI, Kawasaki Kanagawa (JP)

(21) Appl. No.: 14/445,528

(22) Filed: Jul. 29, 2014

(30) Foreign Application Priority Data
Mar. 14, 2014 (JP) 2014-051758

(51) Int. Cl. H04N 5/374; H04N 5/225

(52) U.S. Cl. CPC H04N 5/374; H04N 5/2253; H04N 5/2254

(57) ABSTRACT

A camera module includes a metal plate including a recessed portion, a flexible printed board having a portion that is accommodated in the recessed portion, an image sensor arranged on the portion of the printed board accommodated in the recessed portion, and a case including a lens for guiding light to the image sensor.

### CROSS-REFERENCE TO RELATED APPLICATION

This application is based upon and claims the benefit of priority from Japanese Patent Application No. 2014-051758, filed Mar. 14, 2014, the entire contents of which are incorporated herein by reference.

### FIELD

Embodiments described herein relate generally to a camera module.

### BACKGROUND

In the related art, electronic devices such as cellular phones and modules mounted in the electronic devices, e.g., a camera module, have reduced in thickness.

### DESCRIPTION OF THE DRAWINGS

FIG. 1 is a top plan view illustrating one example of a camera module according to a present embodiment.

FIG. 2 is a cross-sectional view taken along the line II-II of FIG. 1.

FIGS. 3-6 are each a cross-sectional view illustrating one step of a method of manufacturing the camera module according to the present embodiment.

### DETAILED DESCRIPTION

In general, according to one embodiment, there is provided a camera module configuration that is capable of reducing the overall thickness of the camera module.

According to the embodiment, there is provided a camera module including a metal plate including a recessed portion, a flexible printed board having a portion that is accommodated in the recessed portion, an image sensor arranged on the portion of the printed board accommodated in the recessed portion, and a case including a lens for guiding light to the image sensor.

Hereinafter, embodiments will be described with reference to the drawings. In the drawings, the same reference numbers depict the same portions.

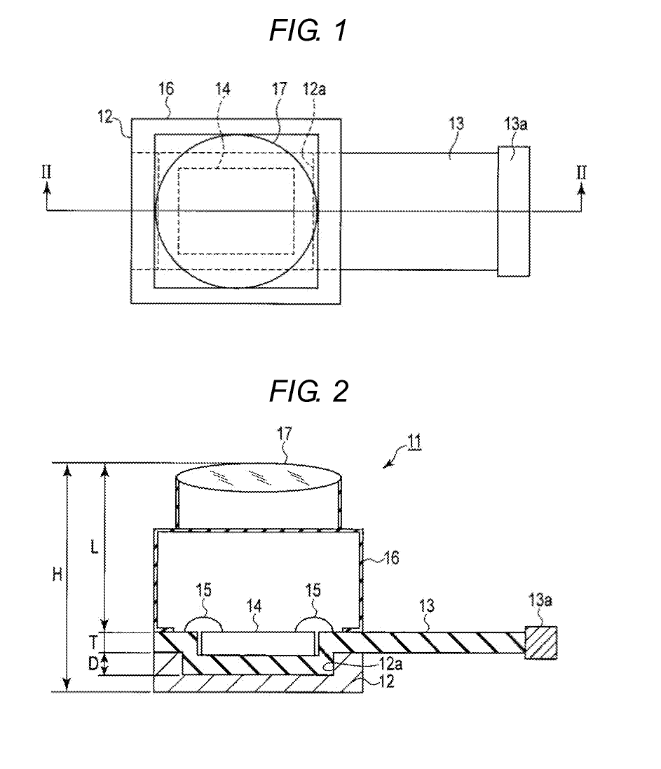

FIGS. 1 and 2 schematically illustrate a camera module according to the embodiment. In FIGS. 1 and 2, a metal plate 12 is provided at the bottom of a camera module 11. This metal plate 12 is made of a metal having a high thermal conductivity, for example, a stainless steel. A concave or recessed portion 12a is formed in the surface of the metal plate 12. One end portion of a printed board having flexibility (hereinafter, referred to as a flexible printed board) 13 in the longitudinal direction is accommodated in the concave portion 12a.

In this embodiment, the “concave portion” indicates a recessed portion in which a portion of the printed board is accommodated, and the concave portion includes a first portion that supports the printed board on the bottom side and a second portion that supports the same on the lateral side.

As illustrated in FIG. 1, the width of the concave portion 12a is substantially equal to the width of the flexible printed board 13 in a direction orthogonal to the longitudinal direction and one end portion of the flexible printed board 13 is bent and accommodated in the concave portion 12a. In this state, the flexible printed board 13 is bonded to the metal plate 12, for example, by a bonding agent not illustrated. On the other end of the flexible printed board 13, for example, a connector 13a is provided.

An image sensor, for example, a CMOS sensor 14 is die-bonded to the portion of the flexible printed board 13 that is within the concave portion 12a. The image sensor is not limited to a CMOS sensor. The depth (height of the side wall of the concave portion 12a) D of the concave portion 12a is set substantially equal to, for example, the thickness T of the flexible printed board 13 and the thickness of the CMOS sensor 14 is substantially equal to the thickness of the flexible printed board 13. Therefore, when the CMOS sensor 14 is die-bonded to the flexible printed board 13 within the concave portion 12a, the level of the upper surface of the CMOS sensor 14 is substantially flush with the level of the upper surface of the portion of the flexible printed board 13 that is not bent and accommodated in the concave portion 12a.

The depth D of the concave portion 12a is not limited to the above, but the depth D may be, for example, greater than or equal to the thickness T of the flexible printed board 13, or the sum of the thickness T of the flexible printed board 13 and the thickness of the CMOS sensor 14, within the range of the thickness of the metal plate 12.

A plurality of bonding pads, not illustrated, are provided on the surface of the CMOS sensor 14 and these bonding pads are connected to bonding pads, not illustrated, provided on the flexible printed board 13 through bonding wires 15.

An optical housing (hereinafter, referred to as a case) 16 covering the CMOS sensor 14 is, for example, bonded to the flexible printed board 13 positioned near the periphery of the concave portion 12a. A lens 17 is provided on the top of the case 16. This lens 17 is positioned on the optical axis of the CMOS sensor 14.

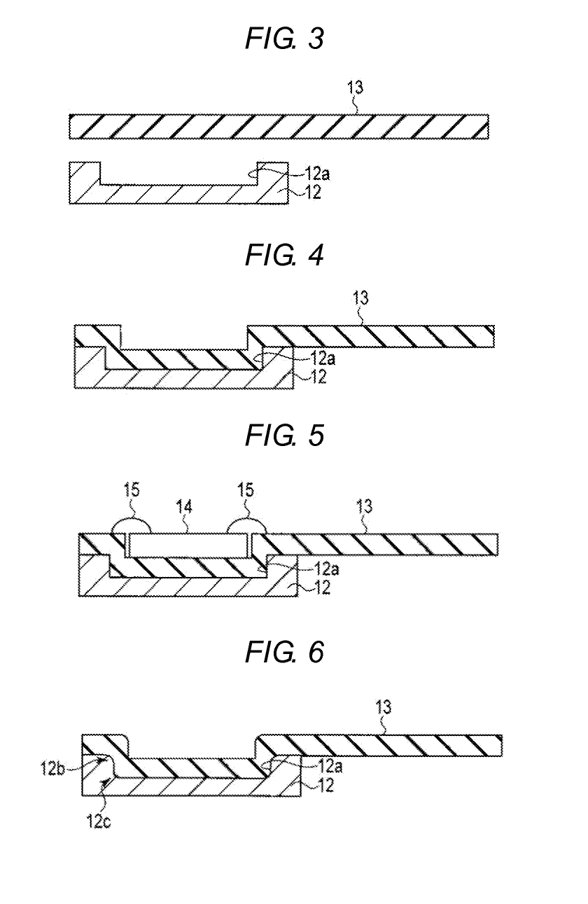

FIGS. 3 to 5 illustrate a method of manufacturing the camera module according to the embodiment. At first, as illustrated in FIG. 3, the metal plate 12 having the concave portion 12a and the plate shaped flexible printed board 13 are prepared.

Then, as illustrated in FIG. 4, the flexible printed board 13 is bent and accommodated into the concave portion 12a. In this state, the flexible printed board 13 is bonded to the metal plate 12 by a bonding agent not illustrated.

Thereafter, as illustrated in FIG. 5, the CMOS sensor 14 is die-bonded to the flexible printed board 13 within the concave portion 12a, and a plurality of bonding pads, not illustrated, on the CMOS sensor 14 are connected to the bonding pads, not illustrated, on the flexible printed board 13 by the bonding wires 15.

As illustrated in FIGS. 1 and 2, the case 16 with the lens 17 is, for example, bonded to the flexible printed board 13.

According to the embodiment, the metal plate 12 includes the concave portion 12a, the flexible printed board 13 is accommodated in the concave portion 12a, and the CMOS sensor 14 is provided on the portion of the flexible printed board 13 that is within the concave portion 12a. Therefore, as illustrated in FIG. 2, when the case 16 with the lens 17 is set on the flexible printed board 13, a distance L from the surface of the CMOS sensor 14 to the surface of the lens 17 maybe secured. Therefore, optical properties maybe secured.

As the CMOS sensor 14 is provided on the portion of the flexible printed board 13 that is within the concave portion 12a, a height H of the module may be lowered and this is suitable for the mount in a thin electric device such as a thinned cellular phone.

Here, by making the depth of the concave portion 12a be greater than or equal to the thickness T of the flexible printed board 13, or the sum of the thickness T of the flexible printed board 13 and the thickness of the CMOS sensor 14, within the range of the thickness of the metal plate 12, the distance L from the surface of the CMOS sensor 14 to the surface of the lens 17 may be secured and the height H of the module may be further reduced.

Further, according to the embodiment, the flexible printed board 13 is bonded to the bottom of the concave portion 12a of the metal plate 12. Therefore, as the flexible printed board 13 within the concave portion 12a is supported by the rigid metal plate 12, the flexible printed board 13 may be flattened and the CMOS sensor 14 may be held flat. Therefore, a distortion of the CMOS sensor 14 may be avoided and the performance of the CMOS sensor 14 may be secured.

Further, in the case of the embodiment, the flexible printed board 13 is fixed to the metal plate 12 by the bonding agent. Therefore, it is not necessary to use an expensive anisotropic conductive film (ACF) and a rigid flexible printed board. As the result, the manufacturing cost may be reduced.

### MODIFIED EXAMPLE

FIG. 6 illustrates a modified example of the embodiment. In FIGS. 1 to 5, the upper peripheral edges and the bottom peripheral edges of the concave portion 12a of the metal plate 12 are formed at right angle.

On the contrary, in a modified example illustrated in FIG. 6, the upper peripheral edges and the bottom peripheral edges of the concave portion 12a of the metal plate 12 include curved portions 12b and 12c, respectively. The curved portions 12b and 12c maybe formed during the process of forming the concave portion 12a, for example, through etching of the metal plate 12.

As mentioned above, by forming the curved portions 12b and 12c on the upper peripheral brim and the bottom periphery of the concave portion 12a, when one end portion of the flexible printed board 13 is accommodated into the concave portion 12a, the flexible printed board 13 is curved along the curved portions 12b and 12c. Therefore, a breakage of the flexible printed board 13 and a warp of the flexible printed board 13 positioned in the bottom of the concave portion 12a may be avoided, which may further flatten the image sensor mounting surface of the flexible printed board 13. Accordingly, a distortion of the CMOS sensor 14 may be further avoided and the performance of the CMOS sensor 14 may be secured.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera module comprising:
a metal plate including a recessed portion;
a flexible printed board having a portion that is accommodated in the recessed portion;
an image sensor arranged on the portion of the printed board that is accommodated in the recessed portion; and
a case including a lens for guiding light to the image sensor.

2. The camera module according to claim 1, wherein
a height of a side wall of the recessed portion is greater than or equal to a thickness of the printed board.

3. The camera module according to claim 1, wherein
a height of a side wall of the recessed portion is greater than or equal to the sum of a thickness of the printed board and a thickness of the image sensor.

4. The camera module according to claim 1, wherein
an upper end and a lower end of a side wall of the recessed portion include curved portions.

5. The camera module according to claim 1, wherein the recessed portion is rectangular and the portion of the printed board that is accommodated in the recessed portion is rectangular.

6. The camera module according to claim 1, wherein the portion of the printed board accommodated in the recessed portion of the metal plate is bonded to the recessed portion of the metal plate.

7. The camera module according to claim 1, wherein the image sensor is a CMOS sensor.

8. The camera module according to claim 1, wherein the case has a bottom edge in contact with the printed board around the image sensor to form an enclosure for the image sensor.

9. A module comprising:
a supporting member with a recessed portion;
a substrate having a portion that is accommodated in the recessed portion;
a component mounted on the portion of the substrate that is accommodated in the recessed portion; and
a case having a bottom edge provided on the substrate and positioned above a periphery of the recessed portion to accommodate the component therein.

10. The module according to claim 9, wherein
a height of a side wall of the recessed portion is greater than or equal to a thickness of the substrate.

11. The module according to claim 9, wherein
a height of a side wall of the recessed portion is greater than or equal to the sum of a thickness of the substrate and a thickness of the component.

12. The module according to claim 9, wherein
an upper end and a lower end of a side wall of the recessed portion include curved portions.

13. The module according to claim 9, wherein the recessed portion is rectangular and the portion of the substrate that is accommodated in the recessed portion is rectangular.

14. The module according to claim 9, wherein the portion of the substrate accommodated in the recessed portion of the supporting member is bonded to the recessed portion of the supporting member.

15. The module according to claim 9, wherein the component is a CMOS sensor.

16. A method of manufacturing a camera module, comprising:
mounting a portion of a flexible printed board in a recessed portion of a metal plate;
bonding an image sensor to the portion of the flexible printed board that is mounted within the recessed portion of the metal plate; and
mounting a case above and around the image sensor.

17. The method according to claim 16, wherein the case includes a bottom edge that is mounted onto the flexible printed board and surrounds the image sensor.

18. The method according to claim 16, wherein
a height of a side wall of the recessed portion is greater than or equal to a thickness of the substrate.

19. The method according to claim 16, wherein
an upper end and a lower end of a side wall of the recessed portion include curved portions.

20. The method according to claim 16, wherein the portion of the flexible printed board mounted in the recessed portion of the metal plate is bonded to the recessed portion of the metal plate.
